(19) United States
(12) Patent Application Publication
(10) Pub. No.: US 2026/0284601 A1
(43) Pub. Date: Sep. 24, 2026

(54) CONDUCTIVE HOLLOW FIBER MEMBRANE AND PREPARATION METHOD THEREOF AND MEMBRANE ASSEMBLY

(71) Applicants: Cangzhou Institute of Tiangong University, Hebei (CN); Tiangong University, Tianjin (CN)

(72) Inventors: Jie WANG, Tianjin (CN); Xu ZHU, Tianjin (CN); Ziyang ZHANG, Tianjin (CN); Hui JIA, Tianjin (CN)

(73) Assignees: Cangzhou Institute of Tiangong University, Hebei (CN); Tiangong University, Tianjin (CN)

(21) Appl. No.: 19/550,204

(22) Filed: Feb. 25, 2026

(30) Foreign Application Priority Data
Mar. 20, 2025 (CN) 202510328913.4

(51) Int. Cl. B01D 69/08; B01D 63/02; B01D 69/02; B01D 71/34; C02F 1/469

(52) U.S. Cl. CPC B01D 69/087; B01D 63/0231; B01D 69/02; B01D 71/34; C02F 1/469; B01D 2323/081; B01D 2323/12; B01D 2323/21836; B01D 2323/226; B01D 2325/26

(57) ABSTRACT

A preparation method of a conductive hollow fiber membrane, including the following steps: adding a functional monomer into a solvent, mixing to obtain a functional monomer solution, adding a polymerizable vinylimidazolium-based ionic liquid into the functional monomer solution, and stirring uniformly under heating conditions to obtain a modified solution; immersing a lining support layer into the modified solution, incubating at room temperature, then transferring the lining support layer to a weak acid buffer solution for in-situ polymerization, and after completion of the reaction, washing and drying to obtain a conductive lining support layer; performing spinning on it, and subjecting it to phase inversion in a coagulation bath to obtain a membrane filament, immersing the membrane filament in pure water and glycerol in sequence, and drying to obtain a final product.

### CROSS-REFERENCE TO RELATED APPLICATION

This application claims priority to Chinese Patent Application No. 202510328913.4, filed on Mar. 20, 2025, which is hereby incorporated by reference in its entirety.

### TECHNICAL FIELD

The present disclosure belongs to the field of hollow fiber membranes, and in particular relates to a conductive hollow fiber membrane and a preparation method thereof, and a membrane assembly.

### BACKGROUND

Membrane separation technology is widely applied in water treatment fields such as drinking water purification, industrial water treatment, wastewater treatment and reuse, and seawater desalination due to its integrated functions of separation, concentration, and purification as well as characteristics of energy conservation, high efficiency and environmental friendliness. It is an important technology for addressing issues such as water resource scarcity and environmental pollution. However, traditional membrane separation technology still has problems such as severe membrane fouling, which leads to reduced separation efficiency, failing to exert its performance effectively. Electrochemical technology is extensively used in the field of water treatment because of its ability to efficiently remove pollutants. Coupling electrochemical technology with membrane separation and leveraging electrostatic repulsion, electrochemical oxidation and other effects is expected to alleviate the problem of membrane fouling during the application of membrane separation technology, making it an environmentally friendly and highly practically applicable novel membrane separation technology. At present, the method for constructing a conductive membrane usually involves modifying the outer layer of the membrane with conductive materials (e.g., polypyrrole, polyaniline, carbon nanotubes, etc.) to enhance its conductivity, but it is prone to causing membrane pore blockage, resulting in a significant decrease in water flux.

### SUMMARY

In view of this, the present disclosure aims to provide a conductive hollow fiber membrane and a preparation method thereof and a membrane assembly, to overcome the defects in the prior art.

To achieve the above objectives, technical solutions of the present disclosure are achieved as follows.

A preparation method of a conductive hollow fiber membrane, comprising following steps:

Step 1: adding a functional monomer into a solvent, and mixing to obtain a functional monomer solution, adding a polymerizable vinylimidazolium-based ionic liquid into the functional monomer solution, and stirring uniformly under heating condition to obtain a modified solution;

Step 2: immersing a lining support layer into the modified solution, incubating at room temperature, then transferring the lining support layer to a weak acid buffer solution for in-situ polymerization, and after completion of the reaction, washing and drying to obtain a conductive lining support layer;

Step 3: performing spinning on the conductive lining support layer, subjecting it to phase inversion in a coagulation bath to obtain a membrane filament, immersing the membrane filament in pure water and glycerol in sequence, and drying to obtain a conductive hollow fiber membrane with a lining structure.

The preparation principle of the conductive hollow fiber membrane mainly lies in: the functional monomer is used to perform in-situ polymerization under weak acid conditions with an oxidant (ferric chloride or ammonium persulfate) and deposited on the lining support layer to form a conductive polymer layer; the addition of the ionic liquid, on one hand, acts as a green solvent to improve the dispersion degree of the functional monomer, and on the other hand, it serves as a comonomer to copolymerize with pyrrole to form a conductive cross-linked structure, and meanwhile the ions in the ionic liquid further enhance the conductivity. Subsequently, a hollow fiber membrane with a conductive lining is prepared through wet spinning technology.

Further, the functional monomer in the functional monomer solution in Step 1 is pyrrole; the functional monomer solution in Step 1 has a concentration of 10-50g/L; and the heating in Step 1 is at a temperature of 10-50°C.

Further, the polymerizable vinylimidazolium-based ionic liquid in Step 1 is at least one of 1-butyl-3-vinylimidazolium chloride, 1-butyl-3-vinylimidazole or 1-butyl-3-vinylimidazolium tetrafluoroborate; and a mass ratio of the polymerizable vinylimidazolium-based ionic liquid to the functional monomer is 1:1-5.

Further, time of the incubating in Step 2 is 30-60min.

Further, the weak acid buffer solution in Step 2 contains an oxidant, and the oxidant has a concentration of 10-50g/L; the oxidant is ferric chloride and/or ammonium persulfate; and time of the in-situ polymerization in Step 2 is 30-60min.

Further, a spinning solution used in the spinning in Step 3 is polyvinylidene fluoride spinning solution, a feed pump speed of the spinning solution is 1-50rpm/min, and the winding roller has a traction speed of 1-30m/min for the lining support layer.

A conductive hollow fiber membrane is prepared by the preparation method as described.

A weak electric field-assisted membrane assembly, which is constructed using the conductive hollow fiber membrane as described, comprises a metal mesh and a conductive hollow fiber membrane filament bundle, where the metal mesh and the conductive hollow fiber membrane filament bundle are connected to an external direct-current power supply to form a weak electric field; where the weak electric field has an anode that is the metal mesh, and a cathode that is the conductive hollow fiber membrane; and the conductive hollow fiber membrane filament bundle includes a plurality of the conductive hollow fiber membranes.

Further, the metal mesh is located on an outer side of the conductive hollow fiber membrane filament bundle; and a material of the metal mesh is titanium or stainless steel.

Further, the conductive hollow fiber membrane filament bundle has a bottom that is a closed structure; and both ends of the conductive hollow fiber membrane filament bundle are each provided with a water collection pipe, and the water collection pipe located at an upper end is provided with a water outlet. The bottom of the conductive hollow fiber membrane filament bundle is sealed with epoxy resin.

In the present disclosure, a conductive polymer doped with a polymerizable vinylimidazolium-based ionic liquid is used as a modification material to modify the lining support layer of the hollow fiber membrane filament; a conductive hollow fiber membrane is prepared through a wet spinning process, followed by conductive packaging and modularization to construct a membrane assembly that can realize the combination of weak electric field assistance and membrane separation function, which is applicable to alleviate membrane pollution in the water treatment process and enhance the pollutant removal efficiency; the conductive polymer is a copolymer formed by oxidative polymerization of the functional monomer, the copolymer is co-deposited on the lining support layer to improve the conductivity of the hollow fiber membrane.

Compared with the prior art, the present disclosure has the following advantages.

The conductive hollow fiber membrane described in the present disclosure utilizes low-cost, easily available, and environmentally friendly functional monomer to form a conductive polymer (such as polypyrrole, polyaniline, etc.) through a simple one-step oxidative polymerization reaction, and in-situ deposit on the lining support layer to endow the lining support layer with conductivity. The incorporation of the ionic liquid further promotes the polymerization reaction to form a copolymer of pyrrole and the ionic liquid, forming a stable conductive coating on the surface of the lining support layer. The modification has little effect on the morphology and size of the lining support layer, and can be well integrated with the existing wet spinning membrane preparation process.

The conductive hollow fiber membrane of the present disclosure exhibits excellent conductivity and high water flux. This is because the conductive coating is modified on the macroporous lining support layer rather than the outer surface of the membrane, which well maintains the water flux and breaks through the “trade-off effect” between conductivity and permeability. In addition, the internal conductive coating is not interfered by pollutants in the external water body, thus being capable of maintaining long-term conductive stability.

The conductive hollow fiber membrane described in the present disclosure has high conductivity, high flux and high mechanical strength. The weak electric field-assisted membrane assembly constructed by using the conductive hollow fiber membrane, when applied to water treatment, can greatly alleviate membrane pollution, reduce the frequency of membrane cleaning, extend the service life of the membrane and improve the efficiency of separation and removal.

A conductive membrane assembly may be constructed by using the conductive hollow fiber membrane filaments described in the present disclosure as an electrode. A weak electric field is formed by applying an external direct-current power supply, which enables electrostatic repulsion and electro-oxidation of pollutants on the membrane surface, significantly alleviating membrane pollution, reducing the frequency of membrane cleaning, and extending the service life of the membrane. The conductive membrane assembly has a reasonable and compact structure, is easy to assemble in a modular manner, can achieve membrane separation under the assistance of a weak electric field, and is suitable for different specifications and different water treatment operation modes.

The preparation process of the conductive hollow fiber membrane of the present disclosure is simple with low production cost, and can be manufactured on an industrial scale in large batches, and is suitable for application in various water treatment scenarios.

### BRIEF DESCRIPTION OF DRAWINGS

FIG. 1 is a schematic diagram of a membrane assembly according to an embodiment of the present disclosure, where figure a is a structural diagram of the membrane assembly, figure b is an internal structural diagram of the membrane assembly, and figure c is a sectional structural diagram of the membrane assembly.

FIG. 2 is a schematic diagram of a conductive hollow fiber membrane according to an embodiment of the present disclosure.

FIG. 3 is a scanning electron microscope image of a conductive hollow fiber membrane according to an embodiment of the present disclosure: where FIG. (a) shows a unmodified lining surface, FIG. (b) shows a modified lining surface, and FIG. (c) shows a cross-section of the conductive hollow fiber membrane.

FIG. 4 is a schematic diagram of a conductive lining support layer according to an embodiment of the present disclosure: where FIG. (a) shows an original lining support layer, and FIG. (b) shows a conductive lining support layer.

FIG. 5 is a comparison diagram of conductivity and flux of conductive hollow fiber membranes described in examples and comparative examples of the present disclosure.

### DESCRIPTION OF REFERENCE NUMERALS

1. water outlet; 2. water collection pipe; 3. metal mesh; 4. conductive hollow fiber membrane filament bundle; 5. wire; 6. lining support layer; 7. conductive modified layer; 8. spinning solution layer.

### DESCRIPTION OF EMBODIMENTS

Unless otherwise defined, the technical terms used in the following examples have the same meanings as those generally understood by a person skilled in the art to which the present disclosure pertains. The experimental reagents used in the following examples are all conventional biochemical reagents unless otherwise specified; the experimental methods described are all conventional methods unless otherwise specified.

The present disclosure is described in detail below with reference to the examples.

### Example 1

A preparation method of a conductive hollow fiber membrane comprises the following steps:
(1) adding 1-butyl-3-vinylimidazolium tetrafluoroborate ionic liquid to a 50g/L of pyrrole aqueous solution with a mass ratio of pyrrole to the ionic liquid of 3, stirring and mixing uniformly at room temperature to obtain a modified solution;
(2) immersing the lining support layer 6 into the modified solution for 3h to make it fully contact with the modified solution, then immersing the immersed lining support layer 6 into a 30g/L of ferric chloride solution, allowing sufficient reaction for 1h at room temperature, rinsing the unreacted reagents with water and air-drying naturally, to form a conductive modified layer 7 on an outer side of the lining support layer 6, obtaining a conductive lining support layer 6;
(3) winding the dried conductive lining on a winding roller for spinning, performing spinning with a wet spinning machine where polyvinylidene fluoride is used as a spinning solution, a feed pump speed is controlled at 10 mL/min and a traction speed of a winding roller is controlled at 20 m/min; undergoing phase inversion in a coagulation bath to obtain a membrane filament, with a spinning solution layer 8 formed on an outer side of the conductive modified layer 7, immersing the membrane filament in pure water for 48h, with water changed several times during this period to wash away residual organic solvent, then transferring the membrane filament into glycerol for immersion for 72h, followed by drying at room temperature to finally obtain the conductive hollow fiber membrane.

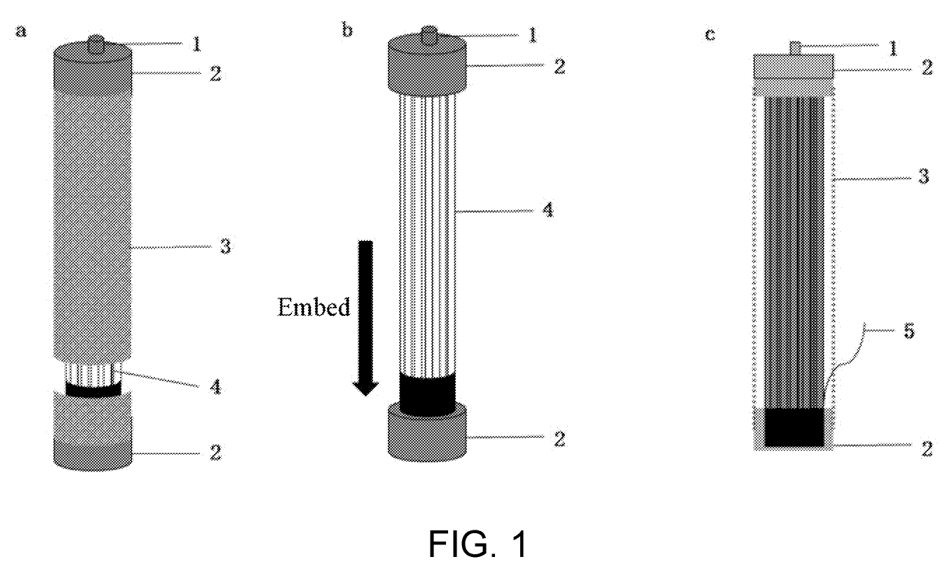

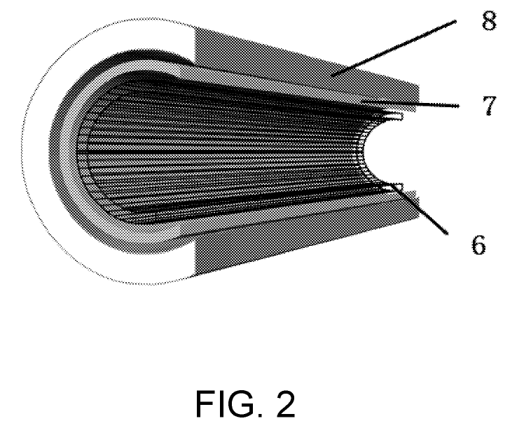

As shown in FIGS. 1-2, a weak electric field-assisted membrane assembly constructed using the conductive hollow fiber membrane includes a metal mesh and a conductive hollow fiber membrane filament bundle 4, where the metal mesh and the conductive hollow fiber membrane filament bundle 4 are connected to an external direct-current power supply to form a weak electric field, where the anode of the weak electric field is the metal mesh, and the cathode is the conductive hollow fiber membrane; and the conductive hollow fiber membrane filament bundle 4 includes a plurality of the conductive hollow fiber membranes.

The metal mesh 3 is located on the outer side of the conductive hollow fiber membrane filament bundle 4. Both ends of the conductive hollow fiber membrane filament bundle 4 are each provided with a water collection pipe 2, and the water collection pipe 2 located at the upper end is provided with a water outlet 1. The bottom of the conductive hollow fiber membrane filament bundle 4 is sealed with epoxy resin.

Both inner and outer sides of the root of the conductive hollow fiber membrane filament bundle 4 are modified with polypyrrole, so that the conductive polymer layer of the lining of the membrane filament is connected to the outer layer of the membrane filament at the root, and then a lead wire 5 is connected through a conductive adhesive. The conductive hollow fiber membrane is used as the cathode, and the metal mesh fixed outside the membrane assembly is used as the anode. They are respectively connected to negative and positive electrodes of the external power supply to provide a direct-current voltage for the entire conductive membrane assembly. The structural schematic diagram of the conductive membrane assembly is shown in FIG. 1.

The lining support layers 6 before and after modification are shown in FIG. 4, where a black coating is formed on the surface of the lining support layer 6 after modification, which is attributed to the rapid oxidation of pyrrole and the ionic liquid by ferric chloride under weak acid conditions generating a black conductive copolymer of pyrrole and the ionic liquid.

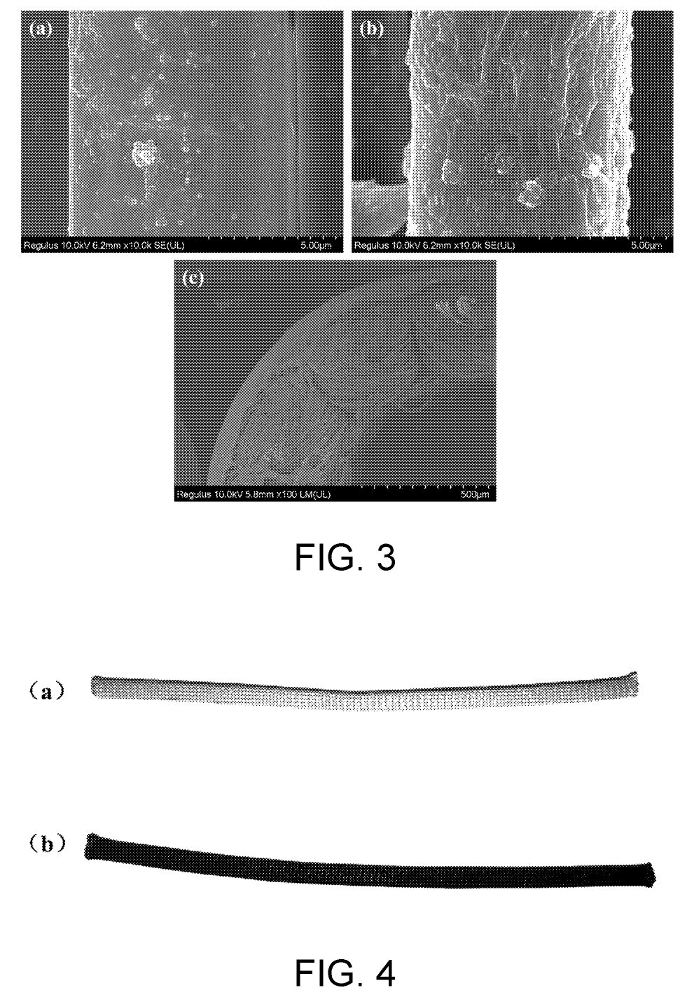

As shown in FIG. 3, the surface of the modified lining becomes rougher and is covered with a layer of clustered polymer, which indicates that the conductive polypyrrole is synthesized and forms a composite polymer with the ionic liquid to be deposited on the surface of the lining. The cross section of the conductive hollow fiber membrane shows a distinct layered interface: the outermost layer is the polyvinylidene fluoride membrane layer, the inner layer is the hollow lining support layer 6, and the conductive polymer layer is located between them.

### Example 2

The difference from Example 1 is only that the pyrrole aqueous solution has a concentration of 25g/L.

### Comparative Example 1

The difference from Example 1 is only that the pyrrole aqueous solution has a concentration of 5g/L.

### Comparative Example 2

The difference from Example 1 is only that the functional monomer is aniline.

### Comparative Example 3

The difference from Example 1 is only that the functional monomer is thiophene.

### Comparative Example 4

The difference from Example 1 is only that the ionic liquid is a 1-ethyl-3-methylimidazolium-based ionic liquid.

### Comparative Example 5

The difference from Example 1 is only that the conductive modified layer 7 is modified on the outer side of the membrane filament surface (i.e., the outer side of the spinning solution layer 8).

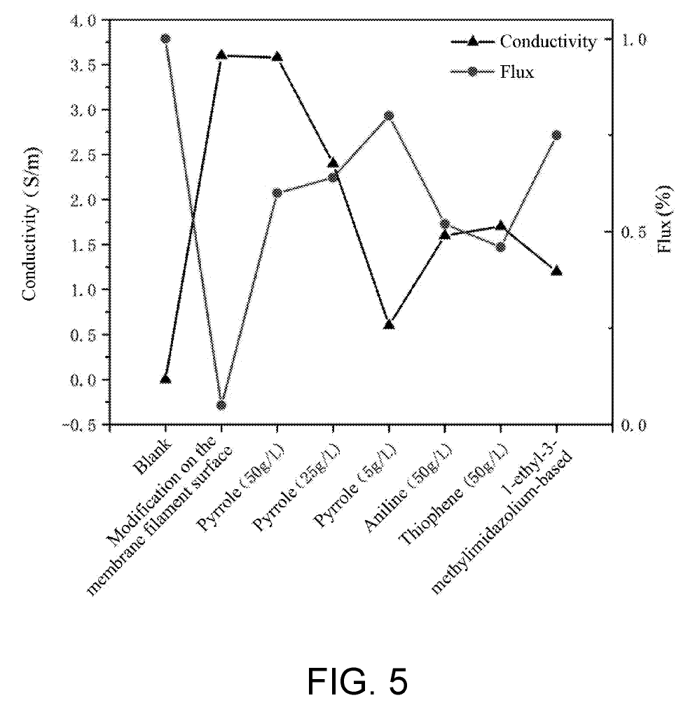

The conductivity of the conductive hollow fiber membranes prepared in the examples and comparative examples was tested, and the results are shown in FIG. 5. The conductivity of the blank membrane filament is 0, indicating that the blank membrane filament is non-conductive, while all the hollow fiber membrane filaments modified with polypyrrole and ionic liquid are conductive, and their conductivity increases with the rise of concentration of pyrrole. When the concentration of pyrrole is 50g/L, the conductivity is 3.6S/m, indicating that more pyrrole participates in the polymerization reaction to form conductive polypyrrole. Moreover, there is no significant difference in conductivity regardless of whether the modification is applied to the membrane surface or the lining support layer 6. Compared with pyrrole monomer, the conductivity of the conductive polymers formed by aniline and thiophene as functional monomers is lower, indicating that polypyrrole has better conductivity. Similarly, when a non-vinyl ionic liquid is selected to participate in the reaction, the conductivity decreases significantly. This indicates that vinyl ionic liquid participates in the reaction during the polymerization process and is co-oxidized with the functional monomer to form the conductive copolymer, thereby proving the feasibility of preparing conductive hollow fiber membranes using the polypyrrole modified lining.

The flux test was carried out on the membrane assembly constructed by the conductive hollow fiber membrane filament prepared in the examples and comparative examples. The results are shown in FIG. 5. It is found that the blank membrane assembly exhibits a relatively high water flux. After the lining support layer 6 is modified with polypyrrole, the flux decreases, and the flux decreases more significantly as the concentration of pyrrole increases, indicating that the formed conductive polymer would affect the pore size of the lining layer to a certain extent, resulting in a decrease in water production capacity. When the concentration of pyrrole is 25g/L, the flux could reach 60% of the original flux, which is within an acceptable range. However, when the conductive layer is coated on the surface of the membrane, the flux is almost 0, indicating that the conductive coating modified on the membrane surface completely blocks pores of the membrane. Comparied with pyrrole, the flux obtained using aniline and thiophene as functional monomers is also significantly lower, since aniline and thiophene also copolymerized with the ionic liquid in the presence of an oxidant. Similarly, use of non-vinyl ionic liquid also shows high flux, indicating that complete polymerization did not occur.

The above description is merely examples of the present disclosure and is not intended to limit the present disclosure. Any modifications, equivalent substitutions, improvements, or the like made within the spirit and principles of the present disclosure shall fall within the protection scope of the present disclosure.

What is claimed is:

1. A preparation method of a conductive hollow fiber membrane, comprising following steps:
Step 1: adding a functional monomer into a solvent, mixing to obtain a functional monomer solution, adding a polymerizable vinylimidazolium-based ionic liquid into the functional monomer solution, and stirring uniformly under heating conditions to obtain a modified solution;
Step 2: immersing a lining support layer into the modified solution, incubating at room temperature, then transferring the lining support layer to a weak acid buffer solution for in-situ polymerization, and after completion of the reaction, washing and drying to obtain a conductive lining support layer;
Step 3: performing spinning on the conductive lining support layer, subjecting it to phase inversion in a coagulation bath to obtain a membrane filament, immersing the membrane filament in pure water and glycerol in sequence, and drying to obtain a conductive hollow fiber membrane with a lining structure.

2. The preparation method of the conductive hollow fiber membrane according to claim 1, wherein the functional monomer in the functional monomer solution in Step 1 is pyrrole; the functional monomer solution in Step 1 has a concentration of 10-50g/L; and the heating in Step 1 is at a temperature of 10-50°C.

3. The preparation method of the conductive hollow fiber membrane according to claim 2, wherein the polymerizable vinylimidazolium-based ionic liquid in Step 1 is at least one of 1-butyl-3-vinylimidazolium chloride, 1-butyl-3-vinylimidazole or 1-butyl-3-vinylimidazolium tetrafluoroborate; and a mass ratio of the polymerizable vinylimidazolium-based ionic liquid to the functional monomer is 1:1-5.

4. The preparation method of the conductive hollow fiber membrane according to claim 1, wherein time of the incubating in Step 2 is 30-60min.

5. The preparation method of the conductive hollow fiber membrane according to claim 1, wherein the weak acid buffer solution in Step 2 contains an oxidant, and the oxidant has a concentration of 10-50g/L; the oxidant is at least one of ferric chloride or ammonium persulfate; and time of the in-situ polymerization in Step 2 is 30-60min.

6. The preparation method of the conductive hollow fiber membrane according to claim 1, wherein a spinning solution used in the spinning in Step 3 is polyvinylidene fluoride spinning solution, the spinning solution has a feed pump speed of 1-50rpm/min, and a winding roller has a traction speed of 1-30m/min for the lining support layer.

7. A conductive hollow fiber membrane prepared by the preparation method according to claim 1.

8. The conductive hollow fiber membrane prepared by the preparation method according to claim 7, wherein the functional monomer in the functional monomer solution in Step 1 is pyrrole; the functional monomer solution in Step 1 has a concentration of 10-50g/L; and the heating in Step 1 is at a temperature of 10-50°C.

9. The conductive hollow fiber membrane prepared by the preparation method according to claim 7, wherein the polymerizable vinylimidazolium-based ionic liquid in Step 1 is at least one of 1-butyl-3-vinylimidazolium chloride, 1-butyl-3-vinylimidazole or 1-butyl-3-vinylimidazolium tetrafluoroborate; and a mass ratio of the polymerizable vinylimidazolium-based ionic liquid to the functional monomer is 1:1-5.

10. The conductive hollow fiber membrane prepared by the preparation method according to claim 7, wherein time of the incubating in Step 2 is 30-60min.

11. The conductive hollow fiber membrane prepared by the preparation method according to claim 7, wherein the weak acid buffer solution in Step 2 contains an oxidant, and the oxidant has a concentration of 10-50g/L; the oxidant is at least one of ferric chloride or ammonium persulfate; and time of the in-situ polymerization in Step 2 is 30-60min.

12. The conductive hollow fiber membrane prepared by the preparation method according to claim 7, wherein a spinning solution used in the spinning in Step 3 is polyvinylidene fluoride spinning solution, the spinning solution has a feed pump speed of 1-50rpm/min, and a winding roller has a traction speed of 1-30m/min for the lining support layer.

13. A weak electric field-assisted membrane assembly constructed using the conductive hollow fiber membrane according to claim 7, comprising a metal mesh and a conductive hollow fiber membrane filament bundle, wherein the metal mesh and the conductive hollow fiber membrane filament bundle are connected to an external direct-current power supply to form a weak electric field; wherein the weak electric field has an anode that is the metal mesh, and a cathode that is the conductive hollow fiber membrane; and the conductive hollow fiber membrane filament bundle comprises a plurality of the conductive hollow fiber membranes.

14. The weak electric field-assisted membrane assembly according to claim 13, wherein the metal mesh is located on an outer side of the conductive hollow fiber membrane filament bundle; and a material of the metal mesh is titanium or stainless steel.

15. The weak electric field-assisted membrane assembly according to claim 13, wherein the conductive hollow fiber membrane filament bundle has a bottom that is a closed structure; and both ends of the conductive hollow fiber membrane filament bundle are each provided with a water collection pipe, and the water collection pipe located at an upper end is provided with a water outlet.
